(19) United States
(12) Patent Application Publication
(10) Pub. No.: US 2012/0268816 A1
(43) Pub. Date: Oct. 25, 2012

(54) FRESNEL LENS STRUCTURE AND 2D/3D IMAGE SWITCHING DISPLAY APPARATUS USING THE SAME

(76) Inventors: Sung-Hak BAE, Seo-gu (KR); Kwang-Seung Park, Yuseong-gu (KR); Sang-Choll Han, Yuseong-gu (KR); Byung-Su Park, Seo-gu (KR)

(21) Appl. No.: 13/543,506

(22) Filed: Jul. 6, 2012

Related U.S. Application Data
(63) Continuation of application No. PCT/KR2012/000882, filed on Feb. 7, 2012.

(30) Foreign Application Priority Data
Feb. 9, 2011 (KR) 10-2011-0011537

(51) Int. Cl. G02B 27/26; B29D 11/00; G02B 3/08

(52) U.S. Cl. 359/463; 359/742; 264/1.7

(57) ABSTRACT

There is provided a Fresnel lens structure including: a Fresnel lens layer; and a planarization layer disposed on the Fresnel lens layer, any one of the Fresnel lens layer and the planarization layer being formed of a birefringent material and the other being formed of an isotropic material having a refractive index equal to a highest refractive index or a lowest refractive index of the birefringent material. In the Fresnel lens structure, a 2/3D image switching structure is simplified and switching thereof is easy. 2/3D switching can be performed without using an apparatus with complicated structure, whereby a stereoscopic image display apparatus structure may be simplified and manufacturing costs may be reduced as compared with a lenticular lens by using a Fresnel shaped lens structure.

### CROSS-REFERENCE TO RELATED APPLICATIONS

This application is a continuation application (bypass application), under 35 USC §120, of International Patent Application No. PCT/KR2012/000882, filed on Feb. 7, 2012, which claims priority to and the benefit of Korean Patent Application No. 10-2011-0011537, filed on Feb. 9, 2011, which is hereby incorporated by reference in its entirety herein.

### BACKGROUND OF THE INVENTION

1. Field of the Invention

The present invention relates to a Fresnel lens structure and a method of manufacturing the same, and more particularly, to a Fresnel lens structure for a 2D/3D image switching display apparatus and a method of manufacturing the same.

2. Description of the Related Art

As a three dimensional (3D) stereoscopic image display apparatus, there are provided a glasses system and a non-glasses system. In the case of the glasses system, a stereoscopic image is generally obtained using polarized lens or shutter lens. The glasses system has strengths in that a viewing angle is relatively wide and a stereoscopic effect is excellent, but there may be inconveniences in which a separate pair of glasses should be purchased and worn. Particularly, when a stereoscopic image display apparatus using the glasses system is applied to portable devices such as mobile phones, tablet PCs, or the like, the necessity of a user constantly keeping 3D glasses close to hand in order to view a stereoscopic image may be inconvenient.

Meanwhile, in the case of a non-glasses system stereoscopic image display apparatus, there may be provided a parallax barrier system and a lenticular lens system. In a parallax barrier system, a barrier filter is disposed at a predetermined distance from the front of a display panel, and then, different images or videos are controlled to be observed by both eyes with a time delay therebetween such that the image or video is displayed three-dimensionally, that is, through a method using a time delay. In this case, switching between 2D/3D may be easy, but a defect in which brightness is reduced by around half may occur.

In the lenticular scheme, in order to separate a visual field of a left-eye image from the visual field of a right-eye image, a lenticular lens array disposed between a display panel and an observer (viewer) is used. In this case, brightness may not be affected at the time of 3D switching, but 2D/3D switching is not facilitated.

Accordingly, the necessity for the development of an image display apparatus facilitating 2D/3D switching without requiring a user to wear glasses and decreasing brightness has increased.

### SUMMARY OF INVENTION

An aspect of the present invention provides a Fresnel lens structure for 2D/3D image switching, for use in a stereoscopic image display apparatus, and a method of manufacturing the same, and a 2D/3D image switching display apparatus using the Fresnel lens structure.

According to an aspect of the present invention, there is provided a Fresnel lens structure including: a Fresnel lens layer; and a planarization layer disposed on the Fresnel lens layer, any one of the Fresnel lens layer and the planarization layer being formed of a birefringent material and the other being formed of an isotropic material having a refractive index equal to a highest refractive index or a lowest refractive index of the birefringent material.

According to another aspect of the present invention, there is provided a method of manufacturing a Fresnel lens structure, including: forming a Fresnel lens layer; and forming a planarization layer on the Fresnel lens layer, any one of the Fresnel lens layer and the planarization layer being formed of a birefringent material and the other being formed of an isotropic material having a refractive index equal to a highest refractive index or a lowest refractive index of the birefringent material.

According to another aspect of the present invention, there is provided a 2D/3D image switching display apparatus including: a display panel; a polarization converter positioned on a viewer side with regard to the display panel and controlling a polarization direction of an output image through an electric control; and the Fresnel lens structure described above, positioned on a viewer side with regard to the polarization converter and switching a stereoscopic image and a plane image according to the polarization direction of the output image.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view showing a structure of a Fresnel lens structure according to an embodiment of the present invention;

FIG. 2 is a cross-sectional view showing a structure of a Fresnel lens structure according to another embodiment of the present invention;

FIG. 3 illustrates a state in which a left-eye image and a right-eye image are separated from each other in a shape of a Fresnel lens;

FIG. 4 illustrates a configuration of a 2D/3D image switching display apparatus using a Fresnel lens structure according to an embodiment of the present invention; and

FIG. 5 illustrates a configuration of a 2D/3D image switching display apparatus using a Fresnel lens structure according to another embodiment of the present invention.

### DETAILED DESCRIPTION OF THE EMBODIMENTS

Embodiments of the present invention will now be described in detail with reference to the accompanying drawings, such that those having ordinary skill in the art to which the invention pertains can easily implement the embodiments described herein. However, it should be noted that the spirit of the present invention is not limited to the embodiments set forth herein and that those skilled in the art and understanding the present invention could easily accomplish retrogressive inventions or other embodiments included in the spirit of the present invention by the addition, modification, and removal of components within the same spirit, but those are to be construed as being included in the spirit of the present invention.

In addition, like or similar reference numerals denote parts performing similar functions and actions throughout the drawings.

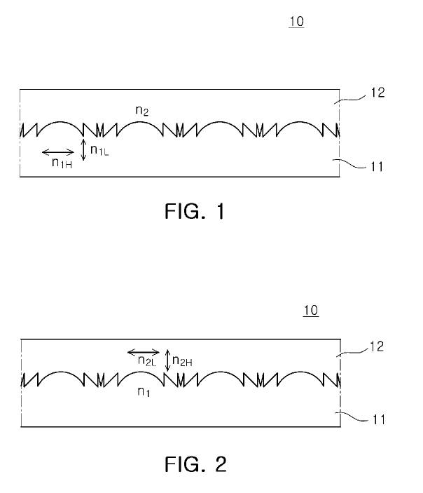

FIG. 1 is a cross-sectional view showing a structure of a Fresnel lens structure according to an embodiment of the present invention, and FIG. 2 is a cross-sectional view showing a structure of a Fresnel lens structure according to another embodiment of the present invention.

Referring to FIGS. 1 and 2, a Fresnel lens structure 10 according to an embodiment of the present invention may include a Fresnel lens layer 11 and a planarization layer 12.

The Fresnel lens layer 11 may have a form in which a plurality of Fresnel lenses are disposed in parallel.

A shape of a Fresnel lens in an embodiment of the present invention may serve to implement a stereoscopic image by separating a left-eye image from a right-eye image in a stereoscopic image display apparatus.

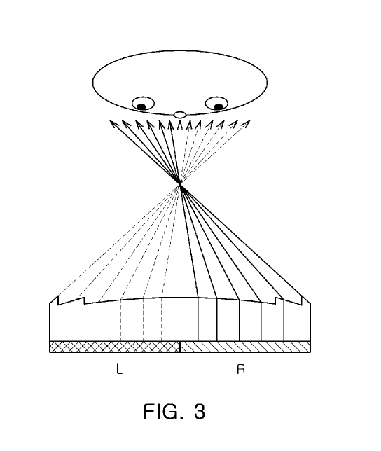

FIG. 3 illustrates a state in which a left-eye image and a right-eye image are separated from each other through a shape of a Fresnel lens.

In a process in which a stereoscopic image is implemented through a shape of a Fresnel lens with reference to FIG. 3, when left-eye pixels and right eye pixels are disposed in a width direction within a Fresnel lens unit, light may be emitted from respective pixels such that it may be linearly passed through the center of the lens, through a shape of a Fresnel lens, that is, a lens having a shape in which lens surface curvature is increased from the center of the lens to an edge thereof when viewed from a display panel side from which the light is emitted. In addition, light passed through a right portion of the lens (a pixel portion for a right eye) may be refracted to the left side such that it is provided to a right eye of a viewer, and light passed through a left portion of the lens (a pixel portion for a left eye) may be refracted to the right side to be provided to a left eye of the viewer. As such, a pixel image for a left eye and a pixel image for a right eye may be separated to be individually provided in different directions, whereby a stereoscopic image may be implemented.

Meanwhile, when the shape of the Fresnel lens is used for implementing a stereoscopic image, since an amount of required raw materials may be reduced, as compared with that of a lenticular lens, lens structure manufacturing costs may be reduced, thereby resulting in a reduction in stereoscopic image display apparatus manufacturing costs. In more detail, in the case of a lens structure used in a stereoscopic image display apparatus, the width of a unit lens may range from about 100 to about 800 μm, SO as to correspond to a pixel width. However, in a case in which a unit lens having a width is implemented to have a lenticular lens shape, although there is merely a difference according to a lens curvature, a height of a unit lens may reach approximately 30 μm to 500 μm. Meanwhile, when a lens structure is formed to have a shape of a Fresnel lens in the same manner as that of the embodiment of the present invention, even in a case in which a lens height thereof is equal to or less than one-third of a height of the lenticular lens, the same level of optical properties as that of the lenticular lens may be obtained. As such, in a case in which the height of a unit lens is relatively low, since the volume of a lens structure may be significantly reduced, a required amount of birefringent material may be significantly reduced, whereby manufacturing costs may be lowered. Further, since a thickness of the overall lens structure may be relatively reduced, a display apparatus may be formed to be thin, and furthermore, since optical loss may be reduced and brightness may increase, optical efficiency may be increased.

The planarization layer 12 may be disposed on the Fresnel lens layer 11 and may serve to allow the Fresnel lens structure 10 to serve as a transparent flat base.

Meanwhile, any one of the Fresnel lens layer 11 and the planarization layer 12 may be formed of a birefringent material and the other may be formed of an isotropic material having a refractive index equal to a highest refractive index or a lowest refractive index of the birefringent material. This is to allow for a stereoscopic image to be implemented by allowing a refractive index of the Fresnel lens layer and the planarization layer to be equal to each other with respect to linear polarized light realizing a 2D image so as to operate the Fresnel lens structure as a transparent flat base and by differentiating a refractive index of the Fresnel lens layer and the planarization layer with respect to linear polarized light realizing a 3D image so as to operate the Fresnel lens structure as a Fresnel lens screen.

A Fresnel lens structure according to an embodiment of the present invention will be described in more detail with reference to FIG. 1.

Referring to FIG. 1, the Fresnel lens layer 11 may be formed of a birefringent material. Here, the birefringent material refers to a material in which refractive indexes of two orthogonal linear polarized light beams passed through the material are different. That is, when among the two refractive indexes, a relatively large refractive index is regarded as a highest refractive index and a relatively small refractive index is regarded as a lowest refractive index, and linear polarized light beams having a highest refractive index n_{1H} and linear polarized light having a lowest refractive index n_{1L}, passed through the Fresnel lens layer 11, may be perpendicular to each other.

Here, in the birefringent material forming the Fresnel lens layer 11, a difference between the highest refractive index n_{1H} and the lowest refractive index n_{1L} may range from 0.05 to 0.3, specifically range from 0.1 to 0.3, and more specifically range from 0.2 to 0.3. Although a birefringent material having a difference between the highest refractive index n_{1H} and the lowest refractive index n_{1L} of less than 0.05 may be present; when the Fresnel lens layer is formed of this material, a refractive difference between the Fresnel lens layer 11 and the planarization layer 12 may be excessively small at the time of outputting of a stereoscopic image such that the Fresnel lens structure 10 maybe operated in the manner of a transparent flat base, whereby the stereoscopic image may not be appropriately implemented. Further, a birefringent material having a difference between the highest refractive index n_{1H} and the lowest refractive index n_{1L} greater than 0.3 may not be present in the case of an organic material, may be present in the case of inorganic crystal, but may not be suitable to be used for a film.

In addition, the Fresnel lens layer 11 is not particularly limited as long as it is a birefringent material, but may be formed of stretched plastic or liquid crystal, and more specifically, may be manufactured by orienting liquid crystal. In detail, the Fresnel lens layer 11 manufactured by orienting liquid crystal may refer to a Fresnel lens layer obtained by coating an upper part of a base with an alignment layer, pouring liquid crystal onto the alignment layer to allow the liquid crystal to be oriented thereon, and then by emitting light thereto and curing the liquid crystal.

In addition, the unit Fresnel lens configuring the Fresnel lens layer 11 may have a shape in which a convex lens is disposed on the center thereof, and in which a plurality of sawtooth shaped lenses are symmetrically disposed on both sides of the convex lens.

In addition, the unit Fresnel lens of the Fresnel lens layer 11 may have a width ranging from 100 to 800 μm. In a case in which a stereoscopic image display apparatus is a mobile device, the unit Fresnel lens of the Fresnel lens layer 11 may have a width ranging 100 to 200 μm, and in a case in which a stereoscopic image display apparatus is a computer monitor or a tablet personal computer display, the unit Fresnel lens of the Fresnel lens layer 11 may have a width ranging 100 to 300 μm. Further, in a case in which a stereoscopic image display apparatus is a television set, the unit Fresnel lens of the Fresnel lens layer 11 may have a width ranging from 400 to 800 μm. A width of the unit Fresnel lens may be generally determined to correspond to the size of two display pixels of a display panel, and the range thereof may satisfy all ranges from the size of display pixels of a small sized display to the size of display pixels of a large sized display.

A height of the unit Fresnel lens of the Fresnel lens layer 11 may range from 1 to 10 μm. When the height of the unit Fresnel lens is less than 1 μm, it may be difficult to obtain a lens effect, and when the height of the unit Fresnel lens exceeds 10 μm, it may be difficult to achieve uniform liquid crystal orientation.

A focus distance of the unit Fresnel lens of the Fresnel lens layer 11 may range from 100 to 6000 μm. When the focus distance is less than 100 μm, it may be difficult to design a lens used for a stereoscopic image display apparatus, and when the focus distance exceeds 6000 μm, a viewing distance may be more than 4 μm, such that it may be difficult to use in everyday life. Here, the focus distance of the Fresnel lens refers to a distance from a lowermost end of the lens to a position on which light is focused.

Meanwhile, the planarization layer 12 may be formed of an isotropic material having a refractive index n₂ equal to a lowest refractive index n_{1L} of the Fresnel lens layer 11. That is, when polarized light having the same directivity as that of linear polarized light having the lowest refractive index n_{1L} of the Fresnel lens layer 11 passes through the Fresnel lens structure 10, the lens structure may be operated in the manner of a transparent flat base such that light is not refracted therethrough, whereby a 2 dimensional image may be obtained. When polarized light having the same directivity as that of linear polarized light having the highest refractive index n_{1H} of the Fresnel lens layer 11 passes through the Fresnel lens structure 10, a refractive index of the Fresnel lens layer 11 may be relatively large as compared to that of the planarization layer 12, and thus, the lens structure may be operated in the manner of a general Fresnel lens sheet to separate a left eye visual field image from a right eye visual field image, whereby a 3 dimensional image may be obtained.

Further, the planarization layer 12 is not particularly limited as long as it is an isotropic material, but may be formed of an acrylic-based UV curing resin. In terms of thickness, the planarization layer 12 may range from 1 to 100 μm, specifically range from 1 to 50 μm, and more specifically range from 1 to 10 μm. In a case in which a thickness of the planarization layer is less than 1 μm, the thickness thereof may be lower than a height of the unit Fresnel lens such that the planarization layer may not be formed, and in a case in which a thickness of the planarization layer is higher than 100 μm, light may be excessively absorbed by the planarization layer such that transmittancy thereof may be reduced.

A Fresnel lens structure according to another embodiment of the present invention will be described in more detail with reference to FIG. 2 below.

With reference to FIG. 2, the Fresnel lens layer 11 refers to a Fresnel lens layer having optically isotropic properties, particularly isotropy with respect to the refractive index. The isotropic material is not particularly limited, but the Fresnel lens layer 11 may be obtained by using an acrylic-based UV curing resin.

Other conditions therefor are the same as those of the Fresnel lens layer of the Fresnel lens structure according to the above-mentioned embodiment of the present invention.

The planarization layer 12 may be formed of a birefringent material, through which a 2D or 3D image may be obtained according to a polarization direction of light passed through the Fresnel lens structure by differentiating a refractive index of the planarization layer according to the polarization direction of light passed through the Fresnel lens structure. Further, although the planarization layer 12 is not particularly limited as long as it is a birefringent material, it may be formed of any one of liquid crystal and stretched plastic, and more specifically, formed of liquid crystal.

Also, with regard to the planarization layer 12, a difference between the highest refractive index n_{2H} and the lowest refractive index n_{2L} may range from 0.05 to 0.3, specifically range from 0.1 to 0.3, and more specifically range from 0.2 to 0.3.

In addition, the planarization layer 12 may be formed of a birefringent material having a highest refractive index n_{2H} equal to a refractive index of the Fresnel lens layer 11. Thus, in a case in which the Fresnel lens structure 10 is used in a stereoscopic image display apparatus, when polarized light having the same directivity as that of linear polarized light having a highest refractive index n_{2H} of the planarization layer 12 passes through the Fresnel lens structure 10, the lens structure may be operated in the manner of a transparent flat base such that a 2 dimensional image may be obtained. Further, when polarized light having the same directivity as that of linear polarized light having a lowest refractive index n_{2L} of the planarization layer 12 passes through the Fresnel lens structure 10, the lens structure may be operated in the manner of a Fresnel lens sheet to separate a left eye visual field image from a right eye visual field image, whereby a 3 dimensional image may be obtained.

A method of manufacturing a lens structure according to an embodiment of the present invention may include forming a Fresnel lens layer; and forming a planarization layer on the Fresnel lens layer.

Here, any one of the Fresnel lens layer and the planarization layer may be formed of a birefringent material and the other may be formed of an isotropic material having a refractive index equal to a highest refractive index or a lowest refractive index of the birefringent material.

In detail, when the Fresnel lens layer 11 is formed of the birefringent material during forming the Fresnel lens layer 11, the planarization layer 12 during forming the planarization layer 12 on the Fresnel lens layer 11 may be formed of an isotropic material having a refractive index equal to a lowest refractive index n_{2L} of the Fresnel lens layer 11, and when the planarization layer 12 during forming the planarization layer 12 on the Fresnel lens layer 11 is formed of the birefringent material, the Fresnel lens layer 11 may be formed of an isotropic material having a refractive index equal to a highest refractive index n_{2H} of the planarization layer 12 during forming the Fresnel lens layer 11.

Further, with regard to the birefringent material, a difference between the highest refractive index thereof and the lowest refractive index thereof may range from 0.05 to 0.3, specifically range from 0.1 to 0.3, and more specifically range from 0.2 to 0.3.

Further, although the birefringent material is not particularly limited, it may be any one of liquid crystal and stretched plastic, and the isotropic material is not particularly limited, but may be an acrylic-based UV curing resin.

Meanwhile, in the forming of the Fresnel lens layer, a unit Fresnel lens of the Fresnel lens layer may have a width ranging from 200 to 800 μm, and the unit Fresnel lens may have a height ranging from 1 to 10 μm, and a focus distance thereof may range from 100 to 6000 μm.

Further, in the forming of the planarization layer, the planarization layer may have a thickness ranging from 1 to 100 μm, specifically ranging from 1 to 50 μm and more specifically ranging from 1 to 10 μm.

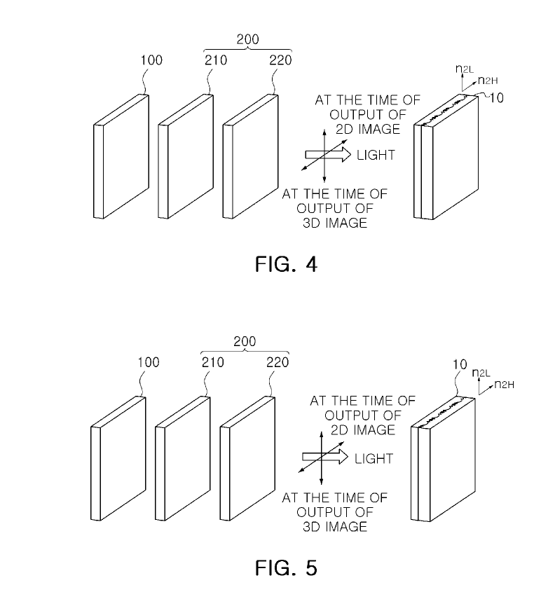

FIG. 4 illustrates a configuration of a 2D/3D image switching display apparatus using a Fresnel lens structure 10 according to the embodiment of the present invention. FIG. 5 illustrates a configuration of a 2D/3D image switching display apparatus using a Fresnel lens structure 10 according to another embodiment of the present invention.

With reference to FIGS. 4 and 5, a 2/3D image switching display apparatus using the Fresnel lens structure 10 according to the embodiment of the present invention may include a display panel 100, a polarization converter 200 and a Fresnel lens structure 10.

The display panel 100 may be a known display panel having rows and columns of display pixels, and is not particularly limited.

The polarization converter 200 may be positioned on a viewer side with regard to the display panel 100 and may include a polarizer 210 and a polarization rotator 220. The polarization rotator 220 may convert a polarization direction of light passed through the polarizer by an electric control, that is, serve to determine a polarization direction of an output image, that is, light passed through the Fresnel lens structure 10.

The Fresnel lens structure 10 may be positioned on a viewer side with regard to the polarization converter 200 and may serve to switch a stereoscopic image and a plane image according to a polarization direction of an output image, that is, light passed through the Fresnel lens structure 10.

Hereinafter, the present invention will be explained in detail with embodiment for implementation of the invention.

### Embodiment (1) Manufacturing of Fresnel Lens Structure

An inverse image of the Fresnel lens may be formed by using a UV curing resin (1.54 in a refractive index at the time of curing) on a base film such as a non-phase difference TAC film, COP film, or the like, without a phase difference therein. On the shape thereof formed above, a liquid crystal alignment layer may be formed by using a composition including a norbornene-based optical reactive polymer containing a cinnarmate group, a multifunctional monomer able to crosslink react with an optical reactive polymer, an optical initiator, and an organic solvent. A rod shaped liquid crystal may be aligned on the formed alignment layer. Here, a lowest refractive index of the liquid crystal may be 1.54, and a highest refractive index thereof may be 1.66. The formed unit Fresnel lens may have a width of 119.4 μm and a height of 5 μ. The number of sawtooth shaped portions forming the unit Fresnel lens may be 10, the convex lens may have a height of 4.1 μm and a width of 44 μm.

In a 2/3D image switching display apparatus using the Fresnel lens structure according to the embodiment of the present invention, since 2/3D switching may be performed without electrically controlling a lens structure, 2/3D switching may be relatively easy, and further, in order to obtain 2/3D switching, since a complicated structure of a conversion apparatus such as an optical modulator or the like may not be used, a stereoscopic image display apparatus structure may be simplified, and since a Fresnel shaped lens structure may be used, manufacturing costs thereof may be reduced.

As set forth above, according to an embodiment of the present invention, 2D image and 3D image switching may be implemented without lowering a brightness level by using a Fresnel lens structure.

In addition, a stereoscopic image and a plane image may be simply switched according to a polarization direction of an output image by using a Fresnel lens structure according to an embodiment of the present invention without the application of power or using a separate light modulation device.

Further, since a Fresnel lens structure according to an embodiment of the present invention has a very thin thickness as compared to a lenticular lens structure used in a stereoscopic image apparatus according to the related art, a thin display apparatus may be implemented, and moreover, since the use of relatively expensive birefringent material can be reduced, manufacturing costs may be reduced.

While the present invention has been shown and described in connection with the embodiments, it will be apparent to those skilled in the art that modifications and variations can be made without departing from the spirit and scope of the invention as defined by the appended claims.

What is claimed is:

1. A Fresnel lens structure comprising:
a Fresnel lens layer; and
a planarization layer disposed on the Fresnel lens layer,
any one of the Fresnel lens layer and the planarization layer being formed of a birefringent material and the other being formed of an isotropic material having a refractive index equal to a highest refractive index or a lowest refractive index of the birefringent material.

2. The Fresnel lens structure of claim 1, wherein the Fresnel lens layer is formed of the birefringent material and the planarization layer is formed of an isotropic material having a refractive index equal to a lowest refractive index of the Fresnel lens layer.

3. The Fresnel lens structure of claim 1, wherein the planarization layer is formed of the birefringent material and the Fresnel lens layer is formed of an isotropic material having a refractive index equal to a highest refractive index of the the planarization layer.

4. The Fresnel lens structure of claim 1, wherein a difference between the highest refractive index and the lowest refractive index of the birefringent material ranges from 0.05 to 0.3.

5. The Fresnel lens structure of claim 1, wherein the birefringent material is a liquid crystal or stretched plastic.

6. The Fresnel lens structure of claim 1, wherein the isotropic material is an acrylic-based UV curing resin.

7. The Fresnel lens structure of claim 1, wherein a unit Fresnel lens of the Fresnel lens layer has a width ranging from 100 to 800 μm.

8. The Fresnel lens structure of claim 1, wherein a unit Fresnel lens of the Fresnel lens layer has a height ranging from 1 to 10 μm.

9. The Fresnel lens structure of claim 1, wherein the Fresnel lens layer has a focus distance ranging from 100 to 6000 μm.

10. The Fresnel lens structure of claim 1, wherein the planarization layer has a thickness ranging from 1 to 100 μm.

11. A method of manufacturing a Fresnel lens structure, comprising:
forming a Fresnel lens layer; and
forming a planarization layer on the Fresnel lens layer,
any one of the Fresnel lens layer and the planarization layer being formed of a birefringent material and the other being formed of an isotropic material having a refractive index equal to a highest refractive index or a lowest refractive index of the birefringent material.

12. The method of claim 11, wherein the Fresnel lens layer is formed of the birefringent material and the planarization layer is formed of an isotropic material having a refractive index equal to a lowest refractive index of the Fresnel lens layer.

13. The method of claim 11, wherein the planarization layer is formed of the birefringent material and the Fresnel lens layer is formed of an isotropic material having a refractive index equal to a highest refractive index of the planarization layer.

14. A 2/3D image switching display apparatus comprising:
a display panel;
a polarization converter positioned on a viewer side with regard to the display panel and controlling a polarization direction of an output image through an electric control; and
the Fresnel lens structure of claim 1, positioned on a viewer side with regard to the polarization converter and switching a stereoscopic image and a plane image according to the polarization direction of the output image.
